(19) United States
(12) Patent Application Publication
(10) Pub. No.: US 2025/0149212 A1
(43) Pub. Date: May 8, 2025

(54) HIGH-POWER CHIP RESISTOR AND MANUFACTURING METHOD THEREOF

(71) Applicant: YAGEO CORPORATION, Kaohsiung City (TW)

(72) Inventors: Shen-Li HSIAO, Kaohsiung City (TW); Chun-Kai YANG, Kaohsiung City (TW); Ren-Hong WANG, Kaohsiung City (TW)

(21) Appl. No.: 18/656,564

(22) Filed: May 6, 2024

(30) Foreign Application Priority Data
Nov. 2, 2023 (TW) 112142215

(51) Int. Cl. H01C 17/00; H01C 1/028; H01C 1/08; H01C 1/142; H01C 17/242

(52) U.S. Cl. CPC H01C 17/006; H01C 1/028; H01C 1/08; H01C 1/142; H01C 17/242

(57) ABSTRACT

A high-power chip resistor includes a resistance layer, a first thermal conductive layer, an adhesion layer, internal electrodes, a first protection layer and a second thermal conductive layer. The first thermal conductive layer includes first thermal conductors and a first gap between the first thermal conductors. The adhesion layer is disposed between the resistance layer and the first thermal conductive layer to adhere them. The internal electrodes are disposed on two terminals of the resistance layer. The first protection layer covers the resistance layer and portions of upper surfaces of the internal electrodes. The second thermal conductive layer is disposed on the first protection layer and includes two second thermal conductors and a second gap between the second thermal conductors. The second thermal conductors contact other portions of upper surfaces located at two terminals of the internal electrodes and not covered by the first protection layer.

### RELATED APPLICATIONS

This application claims priority to Taiwan Application Serial Number 112142215, filed Nov. 2, 2023, which is herein incorporated by reference.

### BACKGROUND

### Technical Field

The invention relates to a resistor and a method of manufacturing thereof, and especially relates to a high-power chip resistor and a method of manufacturing thereof.

### Description of Related Art

In a conventional method of manufacturing chip resistors, a pair of electrodes is formed at two terminals of the substrate, a metal alloy is formed as a resistance layer between the pair of electrodes, and an insulating protection layer is formed to cover the resistance layer to achieve the effects of protection and anti-oxidation. The heat generated by current flowing through the chip resistors is usually conducted through air convection and heat radiation of the substrate (for example, ceramics) itself, or the heat can be introduced into circuit boards through thermal conduction by the electrodes (connected to pads of the circuit boards) at two terminals of the substrate, thereby achieving overall heat dissipation of the chip resistors.

However, if the chip resistors do not have other heat dissipation structures, the temperature of the chip resistors will be too high easily, and the power application range will also be limited due to the high temperature. In addition, the protection layer of the chip resistors will also become brittle due to long-term absorption of heat energy, and thus lose the protection and anti-oxidation functions of the resistance layer.

### SUMMARY

Thus, the purpose of the invention is to provide a high-power chip resistor. The high-power chip resistor includes a resistance layer, a first thermal conductive layer, an adhesion layer, two internal electrodes, a first protection layer and a second thermal conductive layer. The first thermal conductive layer includes two first thermal conductors and a first gap between the two first thermal conductors. The adhesion layer is disposed between the resistance layer and the first thermal conductive layer to adhere the resistance layer and the first thermal conductive layer. The two internal electrodes are disposed on two terminals of the resistance layer respectively. The first protection layer covers the resistance layer and portions of upper surface of the two internal electrodes. The second thermal conductive layer is disposed on the first protection layer, in which the second thermal conductive layer includes two second thermal conductors and a second gap between the two second thermal conductors, and the two second thermal conductors contact other portions of upper surface located at two terminals of the two internal electrodes and not covered by the first protection layer.

According to an embodiment of the invention, the two first thermal conductors and the first gap form a first thermal conductive pattern, the two second thermal conductors and the second gap form a second thermal conductive pattern, and the first thermal conductive pattern and the second thermal conductive pattern are not corresponding to each other.

According to an embodiment of the invention, a third gap between the two internal electrodes that exposes a resistance trimming area, the third gap is filled and covered by the first protection layer.

According to an embodiment of the invention, one of the two first thermal conductors is larger in area than the other one of the two first thermal conductors, and wherein one of the two second thermal conductors is larger in area than the other one of the two second thermal conductors.

According to an embodiment of the invention, the high-power chip resistor further includes a second protection layer and a third protection layer. The second protection layer fills and covers the second gap between the two second thermal conductors and portions of surface of the two second thermal conductors. The third protection layer fills and covers the first gap between the two first thermal conductors and portions of surface of the two first thermal conductors.

According to an embodiment of the invention, the high-power chip resistor further includes two external electrodes, wherein the two external electrodes respectively cover corresponding side walls of the first thermal conductive layer, the resistance layer, the adhesion layer, the two internal electrodes and the second thermal conductive layer.

According to an embodiment of the invention, the adhesion layer is less than 50 micrometers.

According to an embodiment of the invention, the resistance layer includes an upper side and a lower side, the second thermal conductive layer is located on the upper side of the resistance layer, and the first thermal conductive layer is located on the lower side of the resistance layer.

Another purpose of the invention is to provide a method of manufacturing a high-power chip resistor, the method includes: adhering a resistance layer and a first thermal conductive layer by an adhesion layer, wherein the adhesion layer is disposed between the resistance layer and the first thermal conductive layer; patterning and etching the first thermal conductive layer to form two first thermal conductors and a first gap between the two first thermal conductors; forming two internal electrodes on two terminals of the resistance layer respectively; forming a first protection layer to cover the resistance layer and portions of upper surface of the two internal electrodes; and forming a second thermal conductive layer on the first protection layer, wherein the second thermal conductive layer includes two second thermal conductors and a second gap between the two second thermal conductors, and wherein the two second thermal conductors contact another portions of upper surface located at two terminals of the two internal electrodes and not covered by the first protection layer.

According to an embodiment of the invention, the two first thermal conductors and the first gap form a first thermal conductive pattern, the two second thermal conductors and the second gap form a second thermal conductive pattern, and wherein the first thermal conductive pattern and the second thermal conductive pattern are not corresponding to each other.

According to an embodiment of the invention, the method further includes forming a second protection layer to fill and cover the second gap between the two second thermal conductors and portions of surface of the two second thermal conductors; and forming a third protection layer to fill and cover the first gap between the two first thermal conductors and portions of surface of the two first thermal conductors.

According to an embodiment of the invention, the method further includes: forming two external electrodes to respectively cover corresponding side walls of the first thermal conductive layer, the resistance layer, the adhesion layer, the two internal electrodes and the second thermal conductive layer.

According to an embodiment of the invention, the method further includes: forming a resistance trimming area on the resistance layer to obtain a required target resistance value of the resistance layer.

According to an embodiment of the invention, the resistance layer includes an upper side and a lower side, the second thermal conductive layer is formed on the upper side of the resistance layer, and the first thermal conductive layer is formed on the lower side of the resistance layer.

According to an embodiment of the invention, the adhesion layer is less than 50 micrometers.

### BRIEF DESCRIPTION OF THE DRAWINGS

In order to make the above and other objects, features, advantages and embodiments of the invention easier to understand, the accompanying drawings are described as following.

FIG. 1 is a cross-sectional view diagram of a high-power chip resistor according to an embodiment of the invention.

FIG. 2A is a top view diagram of thermal conductive layers of the high-power chip resistor according to an embodiment of the invention.

FIG. 2B is a back view diagram of the thermal conductive layers of the high-power chip resistor according to an embodiment of the invention.

FIG. 3A is a top view diagram of thermal conductive layers of the high-power chip resistor according to another embodiment of the invention.

FIG. 3B is a back view diagram of the thermal conductive layers of the high-power chip resistor according to another embodiment of the invention.

FIG. 4 is a flow diagram of a manufacturing method for manufacturing the high-power chip resistor according to an embodiment of the invention.

FIG. 5A to FIG. 5L illustrate cross-sectional view diagrams of the high-power chip resistor at various manufacturing stages.

### DETAILED DESCRIPTION

The following disclosure provides many different embodiments or examples for implementing different features of the provided subject matter. Embodiments of components and configurations described below are examples only and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Secondly, in order to clearly present the features of the invention, the dimensions (such as length, width, thickness and depth) of the elements (such as layers, films, substrates, regions, etc.) in the drawings are not drawn in scale. Therefore, the description and explanation of the embodiments below are not limited to the sizes and shapes of the components in the drawings, but should cover the sizes, shapes, and deviations caused by actual manufacturing processes and/or tolerances. For example, flat surfaces shown in the drawings may have rough and/or non-linear features, and sharp angles shown in the drawings may be rounded. That is to say, the components shown in the drawings of the invention are mainly for illustration and are not intended to accurately depict the actual shapes of the components, nor are intended to limit the scope of the invention.

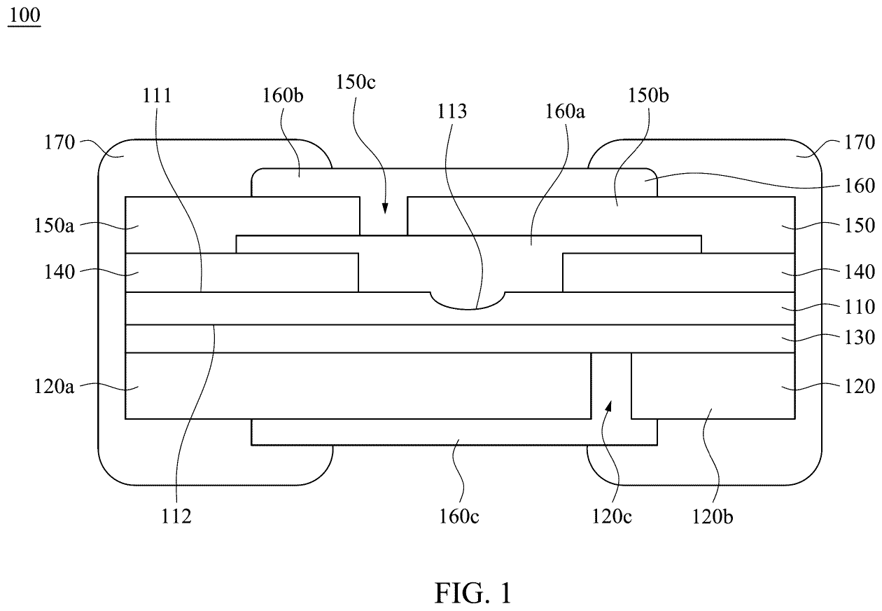

Referring to FIG. 1, FIG. 1 is a cross-sectional view diagram of a high-power chip resistor 100 according to an embodiment of the invention. The high-power chip resistor 100 includes a resistance layer 110, a first thermal conductive layer 120, an adhesion layer 130, two internal electrodes 140, a second thermal conductive layer 150, a plurality of protection layers (for example, a first protection layer 160a, a second protection layer 160b and a third protection layer 160c) and two external electrodes 170. For the purpose of clarity, the resistance layer 110 has an upper surface 111 and a lower surface 112 as shown below and the drawings. The two internal electrodes 140 and the second thermal conductive layer 150 are located on the upper side of the upper surface 111 of the resistance layer 110, and the first thermal conductive layer 120 and the adhesion layer 130 are located on the lower side of the lower surface 112.

As shown in FIG. 1, the resistance layer 110 and the first thermal conductive layer 120 are adhered to each other through the adhesion layer 130. The two internal electrodes 140 are disposed on two terminals of the upper surface 111 of the resistance layer 110 respectively. The second thermal conductive layer 150 is disposed on the two internal electrodes 140 and contacts the underlying internal electrodes 140 at two terminals. In this way, the heat generated by the high-power chip resistor 100 can be directly conducted from the two internal electrodes 140 to the second thermal conductive layer 150, and then the second thermal conductive layer 150 conducts the heat to the external electrodes 170, external circuits or printed circuit boards. In addition, portions of the surface of the first thermal conductive layer 120, the two internal electrodes 140 and the second thermal conductive layer 150 are covered by the protection layer 160. The two external electrodes 170 respectively cover the corresponding side walls of the first thermal conductive layer 120, the resistance layer 110, the adhesion layer 130, the internal electrode 140 and the second thermal conductive layer 150.

The resistance layer 110 includes a resistance trimming area 113, and the resistance value can be adjusted through laser trimming or physical processing processes, thereby obtaining a required target resistance value. In the embodiment, the material of the resistance layer 110 can be copper manganese alloy (MnCu), copper nickel alloy (CuNi), copper manganese nickel alloy (CuMnNi), copper manganese tin alloy (CuMnSn), nickel chromium aluminum alloy (NiCrAl), nickel chromium aluminum silicon alloy (NiCrAlSi), iron chromium aluminum alloy (FeCrAl), or other metal alloys, and the invention is not limited thereto.

The first thermal conductive layer 120 is adhered to the lower surface 112 of the resistance layer 110 through the adhesion layer 130. The first thermal conductive layer 120 includes two first thermal conductors 120a and 120b, and there is a gap 120c between the two first thermal conductors 120a and 120b to make the two first thermal conductors 120a and 120b do not contact each other. The first thermal conductive layer 120 is composed of a metal material with high thermal conductivity (such as copper or aluminum), and the invention is not limited thereto. The heat generated by the resistance layer 110 can be dissipated quicker due to the first thermal conductive layer 120, thereby improving the power withstanding capability of the high-power chip resistor 100. The adhesion layer 130 is not a carrier layer with poor heat dissipation and a thick thickness (for example, a ceramic carrier), but a thin insulating adhesion layer 130 is used to adhere the first thermal conductive layer 120 and the resistance layer 110. In this way, the path for the heat generated by the resistance layer 110 conducted to the first thermal conductive layer 120 can be effectively shortened. In an embodiment of the invention, the thickness of the adhesion layer 130 is approximately less than 50 micrometers (um).

The second thermal conductive layer 150 is disposed on the two internal electrodes 140 and the first protection layer 160a. The second thermal conductive layer 150 includes two second thermal conductors 150a and 150b, and there is a gap 150c between the two second thermal conductors 150a and 150b to make the two second thermal conductors 150a and 150b do not contact each other. The second thermal conductive layer 150 is composed of a metal material with high thermal conductivity (such as copper or aluminum), and the invention is not limited thereto. The second thermal conductive layer 150 increases the thermal conduction path of the high-power chip resistor 100, so that the heat can be directly conducted to the second thermal conductive layer 150 through the two internal electrodes 140, and then conducted to the external electrodes 170, external circuits or printed circuits through the second thermal conductive layer 150. Therefore, the first protection layer 160a is prevented from absorbing heat energy for a long time, which reduces the probability of the first protection layer 160a becoming brittle.

The protection layers 160 are disposed between the layers of the high-power chip resistor 100 to avoid environmental pollution or oxidation, thereby achieving the effects of insulation and protection. The material of the protection layers 160 include but are not limited to epoxy resin, polyimide, acrylic resin or other insulating materials. In the embodiment, the first protection layer 160a covers the resistance trimming area 113 of the resistance layer 110 and portions of upper surface of the two internal electrodes 140. The second protection layer 160b fills and covers the gap 150c between the two second thermal conductors 150a, 150b and portions of the surface of the two second thermal conductors 150a, 150b. The third protection layer 160c fills and covers the gap 120c between the two first thermal conductors 120a, 120b and portions of the surface of the two first thermal conductors 120a, 120b.

The two external electrodes 170 extend from the surface of the second protection layer 160b to the surface of the third protection layer 160c to cover corresponding side walls of the first thermal conductive layer 120, the two internal electrodes 140, the resistance layer 110, the adhesion layer 130 and the second thermal conductive layer 150. The structure of the two external electrodes 170 include a metal layer, a nickel metal layer and a tin metal layer formed sequentially by electroplating processes, in which the outermost tin metal layer provides soldering and adhesion functions between the high-power chip resistor 100 and external circuit boards.

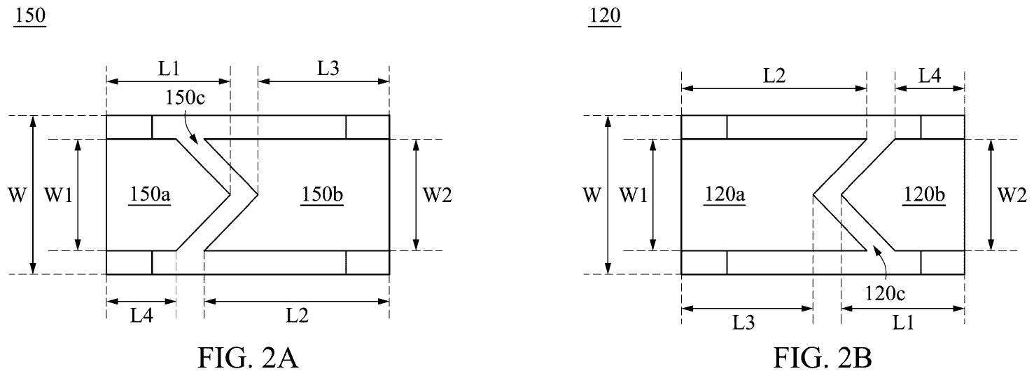

In FIG. 2A and FIG. 2B, a top view diagram and a back view diagram of the first thermal conductive layer 120 and the second thermal conductive layer 150 of the high-power chip resistor 100 according to an embodiment of the invention are further illustrated. In perspective, the second thermal conductor 150a of the second thermal conductive layer 150 corresponds to the first thermal conductor 120a of the first thermal conductive layer 120, and the second thermal conductor 150b of the second thermal conductive layer 150 corresponds to the first thermal conductor 120b of the first thermal conductive layer 120. The gap 150c of the second thermal conductive layer 150 and the gap 120c of the first thermal conductive layer 120 are offset from each other without overlapping. In this way, heat accumulation at the overlap between the gap 150c of the second thermal conductive layer 150 and the gap 120c of the first thermal conductive layer 120 can be avoided, so that the heat can be effectively dissipated and eliminated.

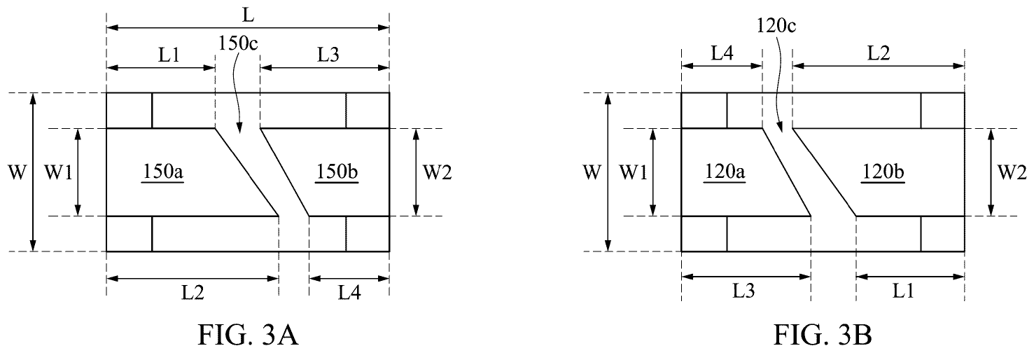

In FIG. 3A and FIG. 3B, a top view diagram and a back view diagram of the first thermal conductive layer 120 and the second thermal conductive layer 150 of the high-power chip resistor 100 according to another embodiment of the invention are further illustrated. In perspective, the second thermal conductor 150a of the second thermal conductive layer 150 corresponds to the first thermal conductor 120a of the first thermal conductive layer 120, and the second thermal conductor 150b of the second thermal conductive layer 150 corresponds to the first thermal conductor 120b of the first thermal conductive layer 120. The gap 150c of the second thermal conductive layer 150 and the gap 120c of the first thermal conductive layer 120 are offset from each other without overlapping. In this way, heat accumulation at the overlap between the gap 150c of the second thermal conductive layer 150 and the gap 120c of the first thermal conductive layer 120 can be avoided, so that the heat can be effectively dissipated and eliminated. It should be understood that FIG. 2A, FIG. 2B, FIG. 3A and FIG. 3B are only exemplary embodiments. In fact, the first thermal conductive layer 120 and the second thermal conductive layer 150 may have any thermal conductive layer pattern on the premise that the gap 120c and the gap 150c are staggered and do not overlap to each other, which are all within the scope of the invention.

In a preferred embodiment of the invention, the length of the high-power chip resistor 100 is L, in which the length L1 is in the range of ½ L to ⅗ L, the length L2 is in the range of ⅗ L to ⅔ L, the length L3 is in the range of ¼ L to 4/15 L, and the length L4 is in the range of ⅗ L to ⅔ L range. The width of the high-power chip resistor 100 is W, in which the width W1 is equal to the width W2 and is in the range of ¾W to W.

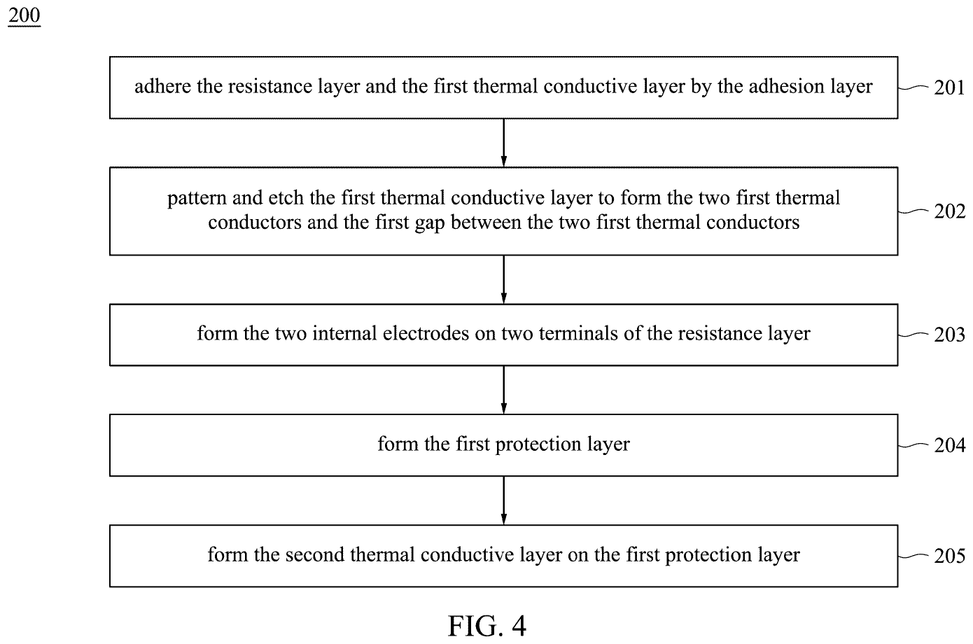

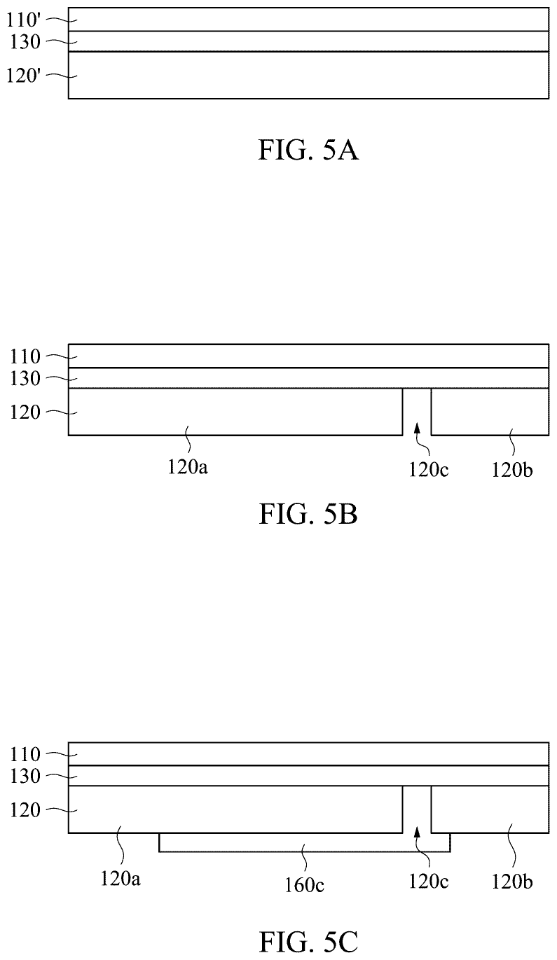

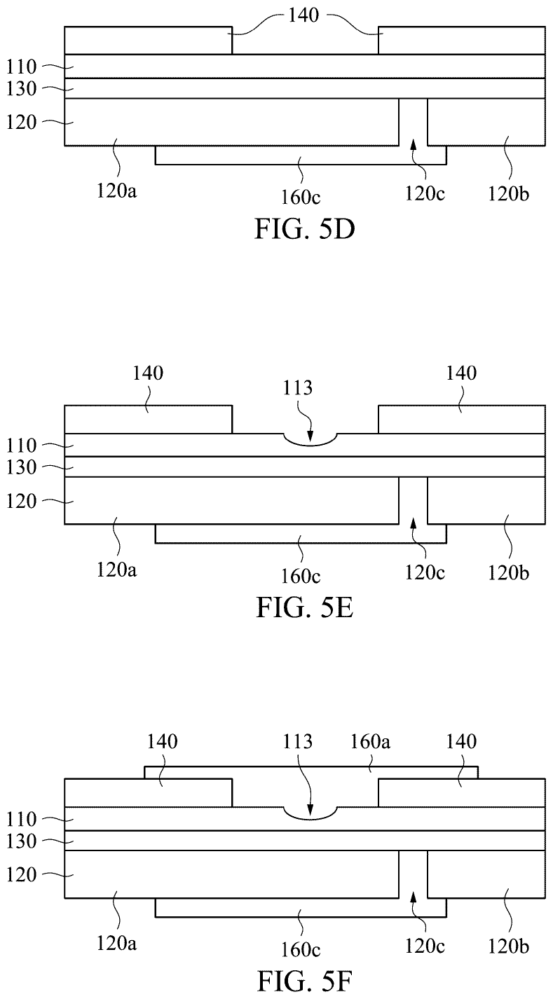

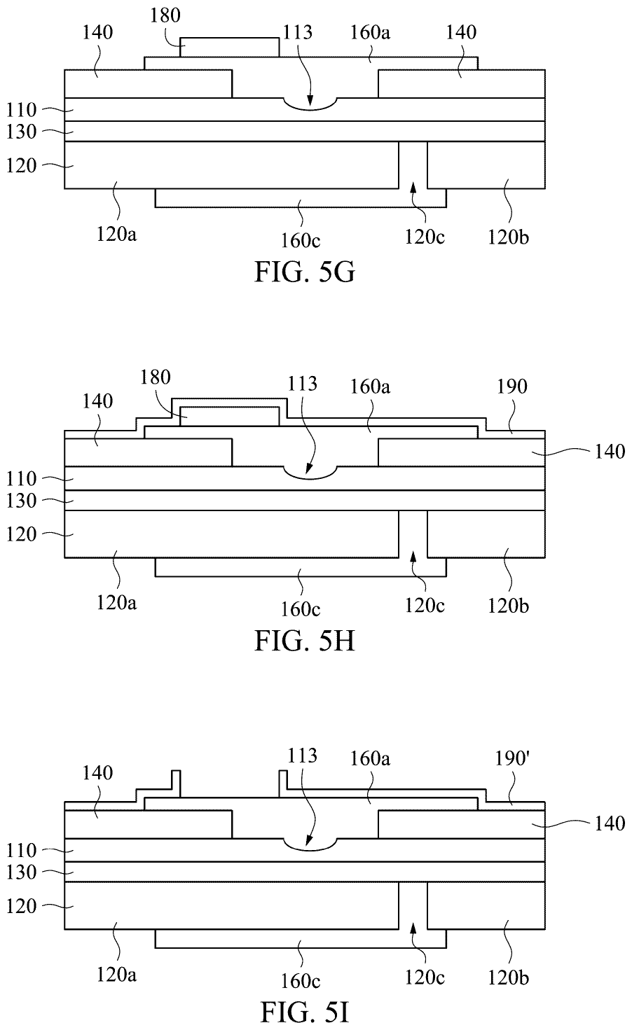

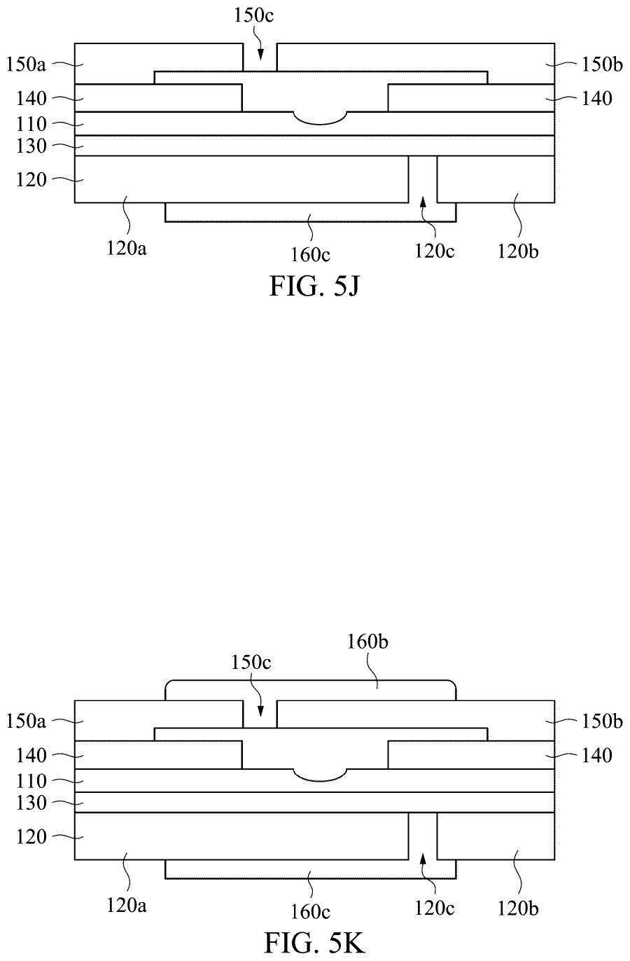

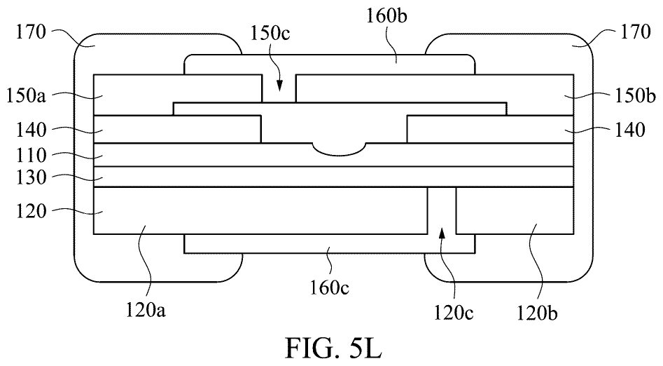

Please refer to FIG. 4. FIG. 4 is a flow diagram of a manufacturing method 200 for manufacturing the high-power chip resistor according to an embodiment of the invention. The manufacturing method 200 can be implemented by the high-power chip resistor 100 shown in FIG. 1, or can be implemented by similar structures that can achieve similar functions. The manufacturing method 200 of FIG. 4 is described with the high-power chip resistor 100 shown in FIG. 1 and FIG. 5A to FIG. 5L. FIG. 5A to FIG. 5L illustrate cross-sectional view diagrams of the high-power chip resistor 100 manufactured by the manufacturing method 200 shown in FIG. 4 at various manufacturing stages.

It should be understood that the manufacturing method 200 is non-limiting example. Although only some operations are briefly described herein, in fact other additional operations may be included before, during, or after the manufacturing method 200 shown in FIG. 4. In addition, the order of operations provided by the manufacturing method 200 is not intended to be limiting. In fact, some operations can be performed in a different order, and some additional operations can also be appropriately modified.

The manufacturing method 200 includes steps 201 to 205. Please refer to FIG. 4 and FIG. 5A (corresponding to step 201). First, the resistance layer 110′ and the first thermal conductive layer 120 are adhered to each other by using the adhesion layer 130.

Please refer to FIG. 4 and FIG. 5B (corresponding to step 202), the resistance layer 110′ and the first thermal conductive layer 120′ are patterned by using a printing process or a photolithography process. Then, the resistance layer 110′ and the first thermal conductive layer 120′ are etched (for example, a wet etching process) to formed into a patterned resistance layer and a patterned first thermal conductive layer respectively (ie, the resistance layer 110 and the first thermal conductive layer 120 shown in FIG. 1). In this embodiment, the first thermal conductive layer 120 includes two first thermal conductors 120a, 120b and a first etching gap between the two first thermal conductors 120a, 120b (ie, the gap 120c shown in FIG. 1). The two thermal conductors 120a, 120b do not contact each other (that is, they are disconnected and do not provide a conductive path) because of the gap 120c.

In FIG. 5C, the third protection layer 160c is formed on portions of the surface of the first thermal conductive layer 120 by using a printing, a lamination, or a photolithography process.

Please refer to FIG. 4 and FIG. 5D (corresponding to step 203), the two internal electrodes 140 are formed on the two terminals of the resistance layer 110. The two internal electrodes 140 can be formed by using electroplating operations. For example, a patterned and removable anti-electroplating protection layer can be covered on the resistance layer 110 by a printing, a laminating, a coating or a photolithography process. The anti-electroplating protection layer can be a photoresist, a removable film or ink, and the invention is not limited thereto. Then, an internal electrode layer is formed on the resistance layer 110. The material of the internal electrode layer is, for example, copper. Finally, the patterned photoresist, the removable film or ink is removed to form the two internal electrodes 140 on the two terminals of the resistance layer 110 by using a stripping solvent or a water washing process.

In FIG. 5E, a resistance adjustment operation is performed on the resistance layer 110 by using laser trimming or physical processing processes, thereby obtaining a required target resistance value. The area used to adjust the resistance value is the resistance trimming area 113 shown in the figure.

Please refer to FIG. 4 and FIG. 5F (corresponding to step 204), the first protection layer 160a is formed on the resistance trimming area 113 of the resistance layer 110 and portions of upper surface of the two internal electrodes 140 by using a printing, a lamination, or a photolithography process.

In FIG. 5G, a patterned and removable mask layer 180 is formed to cover the resistance layer 110 by a printing, a laminating, a coating or a photolithography process. The mask layer 180 can be a photoresist, a removable film or ink, and the invention is not limited thereto.

In FIG. 5H, a metal conductive layer 190 is sputtered on the upper surfaces of the mask layer 180, the first protection layer 160a and the internal electrodes 140 by a sputtering process. The metal conductive layer 190 may be one layer or multiple layers, and the layers may have different materials. The material of the metal conductive layer 190 may be metal alloys, for example, nickel chromium alloy (NiCr), copper nickel alloy (CuNi), copper (Cu), titanium tungsten alloy (TiW), titanium (Ti), copper manganese tin alloy (CuMnSn) or copper manganese nickel alloy (CuMnNi), or other metal conductive materials, and the invention is not limited thereto.

In FIG. 5I, the patterned mask layer 180 (such as photoresist, adhesive film or ink) is removed by using a stripping solvent or water washing method, so that the metal conductive layer 190 is formed into the metal conductive layer 190′ as a seed layer of the second thermal conductive layer 150.

Please refer to FIG. 4 and FIG. 5J (corresponding to step 205), an electroplating operation is performed on the metal conductive layer 190′ to form the second thermal conductive layer 150 based on the pattern of the metal conductive layer 190′. The second thermal conductive layer 150 is a copper layer or an aluminum layer with high thermal conductivity. The second thermal conductive layer 150 includes the two second thermal conductors 150a, 150b and there is a gap 150c between the two second thermal conductors 150a, 150b. Therefore, the two second thermal conductors 150a, 150b do not contact each other (that is, they are disconnected and do not provide a conductive path).

In FIG. 5K, the second protection layer 160b is formed on portions of upper surface of the second thermal conductive layer 150 by using a printing, a lamination, or a photolithography process.

Finally, in FIG. 5L, a copper metal layer, a nickel metal layer and a tin metal layer are formed sequentially by electroplating processes, thereby forming the two external electrodes 170 to cover the corresponding sidewalls of the first thermal conductive layer 120, the internal electrodes 140, the resistance layer 110, the adhesion layer 130 and the second thermal conductive layer 150. By now, the high-power chip resistor 100 is basically completed.

According to the high-power chip resistor and its manufacturing method of the invention, the achievable effects include: using a thinner insulating adhesion layer to adhere the thermal conductive layer and the resistance layer can effectively shorten the path for heat (generated by the resistance layer) to the thermal conductive layer; the thermal conductive layers are provided on both upper and lower sides of the resistance layer, which increases the heat conduction paths and effectively increases heat dissipation speed, among them, the thermal conductive layer on the upper side of the resistance layer can prevent the protection layer from becoming brittle due to long-term absorption of heat energy and improve the reliability of the protection layers; the thermal conductive layers directly contact the underlying internal electrodes at two terminals can improve the heat dissipation efficiency; the thermal conductive layers on the upper side and the lower side of the resistance layer have patterns that do not correspond to each other, which can prevent heat from accumulating in the overlapping gap between the two thermal conductive layers, and the heat can be effectively dispersed and eliminated. In summary, the high-power chip resistor of the invention not only improves the overall heat dissipation efficiency of the chip resistor, but also increases the withstand power range of the chip resistor.

Although the invention has been disclosed in the above embodiments, it is not intended to limit the invention. Anyone with ordinary knowledge in this technical field can make various changes and modifications without departing from the spirit and scope of the invention. Therefore, the scope of the invention shall be determined by the appended patent application scope.

What is claimed is:

1. A high-power chip resistor, comprising:
a resistance layer;
a first thermal conductive layer comprising two first thermal conductors and a first gap between the two first thermal conductors;
an adhesion layer disposed between the resistance layer and the first thermal conductive layer to adhere the resistance layer and the first thermal conductive layer;
two internal electrodes disposed on two terminals of the resistance layer respectively;
a first protection layer covering the resistance layer and portions of an upper surface of the two internal electrodes; and
a second thermal conductive layer disposed on the first protection layer, wherein the second thermal conductive layer comprises two second thermal conductors and a second gap between the two second thermal conductors, and wherein the two second thermal conductors contact other portions of the upper surface located at two terminals of the two internal electrodes and not covered by the first protection layer.

2. The high-power chip resistor of claim 1, wherein the two first thermal conductors and the first gap form a first thermal conductive pattern, the two second thermal conductors and the second gap form a second thermal conductive pattern, the first thermal conductive pattern and the second thermal conductive pattern are not corresponding to each other.

3. The high-power chip resistor of claim 1, wherein a third gap between the two internal electrodes that exposes a resistance trimming area, the third gap is filled and covered by the first protection layer.

4. The high-power chip resistor of claim 1, wherein one of the two first thermal conductors is larger in area than the other one of the two first thermal conductors, and wherein one of the two second thermal conductors is larger in area than the other one of the two second thermal conductors.

5. The high-power chip resistor of claim 1, further comprising:
a second protection layer filling and covering the second gap between the two second thermal conductors and portions of a surface of the two second thermal conductors; and
a third protection layer filling and covering the first gap between the two first thermal conductors and portions of a surface of the two first thermal conductors.

6. The high-power chip resistor of claim 1, further comprising two external electrodes, wherein the two external electrodes respectively cover corresponding side walls of the first thermal conductive layer, the resistance layer, the adhesion layer, the two internal electrodes and the second thermal conductive layer.

7. The high-power chip resistor of claim 1, wherein the adhesion layer is less than 50 micrometers.

8. The high-power chip resistor of claim 1, wherein the resistance layer includes an upper side and a lower side, the second thermal conductive layer is located on the upper side of the resistance layer, and the first thermal conductive layer is located on the lower side of the resistance layer.

9. A method of manufacturing a high-power chip resistor, comprising:
adhering a resistance layer and a first thermal conductive layer by an adhesion layer, wherein the adhesion layer is disposed between the resistance layer and the first thermal conductive layer;
patterning and etching the first thermal conductive layer to form two first thermal conductors and a first gap between the two first thermal conductors;
forming two internal electrodes on two terminals of the resistance layer respectively;
forming a first protection layer to cover the resistance layer and portions of an upper surface of the two internal electrodes; and
forming a second thermal conductive layer on the first protection layer, wherein the second thermal conductive layer comprises two second thermal conductors and a second gap between the two second thermal conductors, and wherein the two second thermal conductors contact other portions of the upper surface located at two terminals of the two internal electrodes and not covered by the first protection layer.

10. The method of claim 9, wherein the two first thermal conductors and the first gap form a first thermal conductive pattern, the two second thermal conductors and the second gap form a second thermal conductive pattern, the first thermal conductive pattern and the second thermal conductive pattern are not corresponding to each other.

11. The method of claim 9, further comprising:
forming a second protection layer to fill and cover the second gap between the two second thermal conductors and portions of a surface of the two second thermal conductors; and
forming a third protection layer to fill and cover the first gap between the two first thermal conductors and portions of a surface of the two first thermal conductors.

12. The method of claim 9, further comprising:
forming two external electrodes to respectively cover corresponding side walls of the first thermal conductive layer, the resistance layer, the adhesion layer, the two internal electrodes and the second thermal conductive layer.

13. The method of claim 9, further comprising:
forming a resistance trimming area on the resistance layer to obtain a required target resistance value of the resistance layer.

14. The method of claim 9, wherein the resistance layer includes an upper side and a lower side, the second thermal conductive layer is formed on the upper side of the resistance layer, and the first thermal conductive layer is formed on the lower side of the resistance layer.

15. The method of claim 9, wherein the adhesion layer is less than 50 micrometers.
